(19) United States
(12) Patent Application Publication
(10) Pub. No.: US 2014/0032746 A1
(43) Pub. Date: Jan. 30, 2014

(54) METHODS FOR MANAGING NETWORK ELEMENTS WITHIN A NETWORK ENVIRONMENT AND DEVICES THEREOF

(71) Applicant: Infosys Limited, Bangalore (IN)

(72) Inventors: Gaurav Saxena, Bangalore (IN); Krishna Chaitanya Garimella, Hyderabad (IN); Ashit Mahendra Shetty, Bangalore (IN)

(73) Assignee: Infosys Limited, Bangalore (IN)

(21) Appl. No.: 13/945,641

(22) Filed: Jul. 18, 2013

(30) Foreign Application Priority Data
Jul. 26, 2012 (IN) 3057/CHE/2012

(51) Int. Cl. H04L 12/26

(52) U.S. Cl. CPC H04L 43/04
USPC 709/224

(57) ABSTRACT

A method, non-transitory computer readable medium and device that manage network elements include interacting with one or more network elements to determine one or more non-functional ones of the network elements. A network diagnostic information is obtained from the determined one or more non-functional network elements. Based on the obtained network diagnostic information, one or more snapshots of the determined one or more non-functional network elements are generated. The management server is provided with the generated one or more snapshots of the determined one or more non-functional network elements.

This application claims the benefit of Indian Patent Application Filing No. 3057/CHE/2012, filed Jun. 26, 2012, which is hereby incorporated by reference in its entirety.

### FIELD

This technology relates to methods for managing elements within a network environment and devices thereof.

### BACKGROUND

Network management refers to activities, methods, procedures, and tools that pertain to the operation, administration, maintenance and provisioning of networked systems. Typical functions performed as part of network management include controlling, planning, allocating, deploying, coordinating, on-demand diagnostics and monitoring of elements on a network.

In most cases, existing network management technologies collect data for network management through server mechanisms, including agents installed on infrastructure, synthetic monitoring that simulates transactions and logs activity, and real user monitoring. Accordingly, for these server mechanisms to function they require access to the network elements. Unfortunately, if these server mechanisms are not able to access and communicate with the network elements, then they can not provide and maintain high quality network operating service resulting in customer dissatisfaction.

### SUMMARY

A method for managing network elements within a network environment includes a mobile computing device interacting with one or more network elements to determine one or more non-functional ones of the network elements. Network diagnostic information is obtained by the mobile computing device from the determined one or more non-functional ones of the network elements. One or more snapshots are generated of the determined one or more non-functional ones of the network elements by the mobile computing device based on the obtained network diagnostic information. The one or more snapshots of the determined one or more non-functional ones of the network elements are provided to the management server by the mobile computing device.

A non-transitory computer readable medium having stored thereon instructions for managing network elements within a network environment comprising machine executable code which when executed by at least one processor, causes the processor to perform steps including interacting with one or more network elements to determine one or more non-functional ones of the network elements. Network diagnostic information is obtained from the determined one or more non-functional ones of the network elements. Based on the obtained network diagnostic information, one or more snapshots are generated of the determined one or more non-functional ones of the network elements. The management server is provided with the generated one or more snapshots of the determined one or more non-functional ones of the network elements.

A mobile computing device comprising one or more processors, a memory, wherein the memory coupled to the one or more processors which are configured to execute programmed instructions stored in the memory including interacting with one or more network elements to determine one or more non-functional ones of the network elements. Network diagnostic information is obtained from the determined one or more non-functional ones of the network elements.

Based on the obtained network diagnostic information, one or more snapshots of the determined one or more non-functional ones of the network elements are generated. The management server is provided with the generated one or more snapshots of the determined one or more non-functional ones of the network elements.

This technology provides a number of advantages including providing more effective methods, non-transitory computer readable medium and devices for managing network elements within a network environment. Additionally, this technology enables access to network even if the network is isolated or if there are issues with an access layer of the network.

### BRIEF DESCRIPTION OF THE DRAWINGS

FIG. 1 is an exemplary network environment with a mobile computing device for managing network elements;

FIG. 2 is a block diagram illustrating the mobile computing device;

FIG. 3 is a flowchart of an exemplary method for managing network elements within a network environment; and

FIG. 4 is an exemplary table illustrating a snapshot

### DETAILED DESCRIPTION

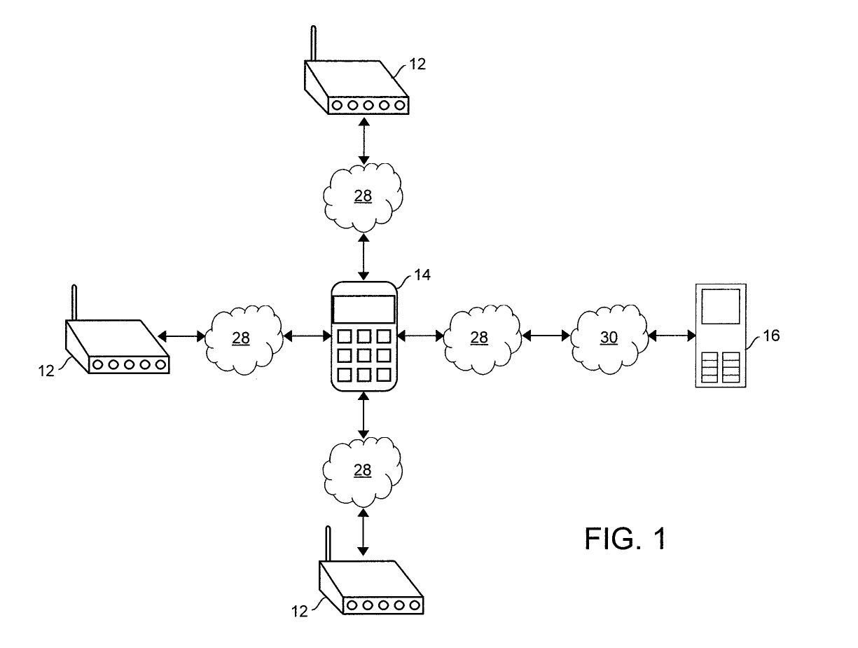

An exemplary network environment 10 with a mobile computing device 14 for managing network elements within a network environment as illustrated in FIG. 1. The exemplary environment 10 includes network elements 12, the mobile computing device 14, management server 16 which are coupled together by the Local Area Network (LAN) 28 and Wide Area Network (WAN) 30, although the environment can include other types and numbers of devices, components, elements and communication networks in other topologies and deployments. While not shown, the exemplary environment 10 may include additional components, such as routers, switches and other devices which are well known to those of ordinary skill in the art and thus will not be described here. This technology provides a number of advantages including providing more effective methods, non-transitory computer readable medium and devices for managing network elements within a network.

Referring more specifically to FIG. 1, the mobile computing device 14 interacts with the network elements 12 through the LAN 28, although the mobile computing device 14 can interact with the network elements 12 via 3G, GPRS or EDGE technologies. Additionally, the mobile computing device 14 interacts with the management server 16 via one or more LAN 28 and WAN 30, although the mobile computing device 14 can interact with the management server using any other network topologies.

The mobile computing device 14 manages one or more network elements within a network environment 10 as illustrated and described with the examples herein, although mobile computing device 14 may perform other types and numbers of functions. The mobile computing device 14 includes at least one processor 18, memory 20, input and display devices 22, and interface device 24 which are coupled together by bus 26, although mobile computing device 14 may comprise other types and numbers of elements in other configurations.

Processor(s) 18 may execute one or more computer-executable instructions stored in the memory 20 for the methods illustrated and described with reference to the examples herein, although the processor(s) can execute other types and numbers of instructions and perform other types and numbers of operations. The processor(s) 18 may comprise one or more central processing units (“CPUs”) or general purpose processors with one or more processing cores, such as AMD® processor(s), although other types of processor(s) could be used (e.g., Intel®).

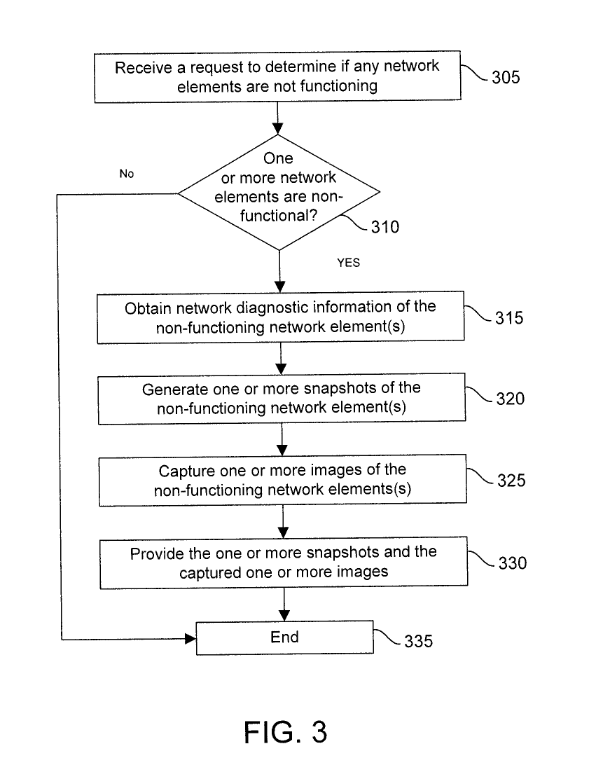

Memory 20 may comprise one or more tangible storage media, such as RAM, ROM, flash memory, CD-ROM, floppy disk, hard disk drive(s), solid state memory, DVD, or any other memory storage types or devices, including combinations thereof, which are known to those of ordinary skill in the art. Memory 20 may store one or more non-transitory computer-readable instructions of this technology as illustrated and described with reference to the examples herein that may be executed by the one or more processor(s) 18. The flow chart shown in FIG. 3 is representative of example steps or actions of this technology that may be embodied or expressed as one or more non-transitory computer or machine readable instructions stored in memory 20 that may be executed by the processor(s) 18.

The configurable hardware logic 21 may comprise specialized hardware configured to implement one or more steps of this technology as illustrated and described with reference to the examples herein. By way of example only, the optional configurable hardware logic 21 may comprise one or more of field programmable gate arrays (“FPGAs”), field programmable logic devices (“FPLDs”), application specific integrated circuits (“ASICs”) and/or programmable logic units (“PLUs”).

Input and display devices 22 enable a user, such as an administrator, to interact with the mobile computing device 14, such as to input and/or view data and/or to configure, program and/or operate it by way of example only. Input devices may include a touch screen, keyboard and/or a computer mouse and display devices may include a computer monitor, although other types and numbers of input devices and display devices could be used.

The interface device 24 in the mobile computing device 14 is used to operatively couple and communicate between the mobile computing device 14, the network elements 12 and the management server 16 which are all coupled together by LAN 28 and WAN 30. By way of example only, the interface device 24 can use TCP/IP over Ethernet and industry-standard protocols, including NFS, CIFS, SOAP, XML, LDAP, and SNMP, TR 069, TR 135 although other types and numbers of communication protocols can be used.

In this example, the bus 26 is a hyper-transport bus in this example, although other bus types and links may be used, such as PCI.

Each of the network elements 12 includes a central processing unit (CPU) or processor, a memory, an interface device, and an I/O system, which are coupled together by a bus or other link, although other numbers and types of network devices could be used. Each of the network elements 12 communicate with the mobile computing device 14 through LAN 28, although the network elements 12 can interact with the mobile computing device 14 by any other means. Additionally, by way of example only, the network elements 12 can use standard TR 069 and TR 135 protocols to communicate with the mobile computing device 14.

The management server 16 includes a central processing unit (CPU) or processor, a memory, an interface device, and an I/O system, which are coupled together by a bus or other link, although other numbers and types of network devices could be used.

Generally, the management server 16 includes one or more instructions to solve network issues associated with the various network elements 12, although other types of information may be present in each of the server 16. A series of applications may run on the servers 16 that allow the transmission of data, such as a data file or metadata, requested by the mobile computing device 14. It is to be understood that the servers 16 may be hardware or software or may represent a system with multiple servers 16, which may include internal or external networks. In this example the servers 16 may be any version of Microsoft® IIS servers or Apache® servers, although other types of servers may be used.

Although an exemplary network environment 10 with the multiple network elements 12, mobile computing device 14, and management server 16 are described and illustrated herein, other types and numbers of systems, devices in other topologies can be used. It is to be understood that the systems of the examples described herein are for exemplary purposes, as many variations of the specific hardware and software used to implement the examples are possible, as will be appreciated by those skilled in the relevant art(s).

Furthermore, each of the systems of the examples may be conveniently implemented using one or more general purpose computer systems, microprocessors, digital signal processors, and micro-controllers, programmed according to the teachings of the examples, as described and illustrated herein, and as will be appreciated by those of ordinary skill in the art.

The examples may also be embodied as a non-transitory computer readable medium having instructions stored thereon for one or more aspects of the technology as described and illustrated by way of the examples herein, which when executed by a processor (or configurable hardware), cause the processor to carry out the steps necessary to implement the methods of the examples, as described and illustrated herein.

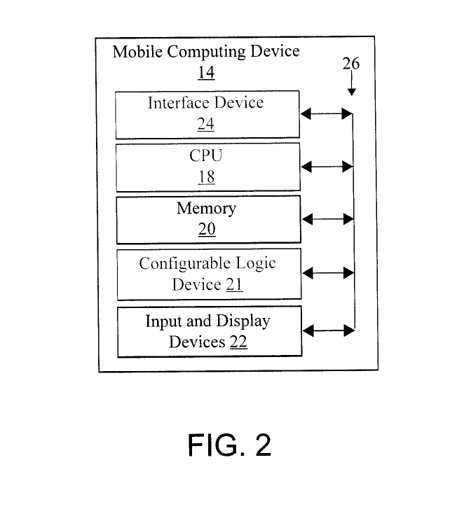

An exemplary method for managing network elements within a network will now be described with reference to FIGS. 1-4. In step 305, the mobile computing device 14 receives a request to determine if any of the one or more network elements 12 are not functioning, although the mobile computing device 14 may receive any other types and numbers of request. By way of example only, a user may request the mobile computing device 14 to determine if any of the network elements 12 within the network environment 10 are currently not functioning.

In step 310, the mobile computing device 14 determines if any of the network elements 12 are not functioning by connecting to the network management interfaces of the network elements 12, although other manners for determining the non-functioning network element 12 could be used. In another example, the mobile computing device 14 determines the non-functioning network elements 12 by periodically obtaining information from the network management interface of the network elements 12 and triggering an alert when the mobile computing device 14 fails to obtain information from the network management interface of the network elements 12. In this example, the mobile computing device 14 interacts with the network management interfaces of one or more network elements 12 through a Wi-Fi connection to determine if any are not functioning, although other types and numbers of connections and communication systems could be used. If the mobile computing device 14 determines all of the network elements 12 are functioning, then the No branch is taken to step 335 where this exemplary method ends. If the mobile computing device 14 determines any of the network elements 12 are not functioning, then a Yes branch is taken to step 315.

In step 315, the mobile computing device 14 obtains network diagnostic information from the one or more network elements 12 determined to be non-functional by using real-time communication protocols, such as TR-069 or TR-135 guidelines for broadband system network development and deployment, which are both therein incorporated by reference in their entirety, although the mobile computing device 14 can obtain network diagnostic information using other methods or techniques. In this example, the network diagnostic information includes upstream data, down stream data, total bandwidth, number of devices connected, last access time, last time active time of the network element, although the network diagnostic information can include other types and amounts of data.

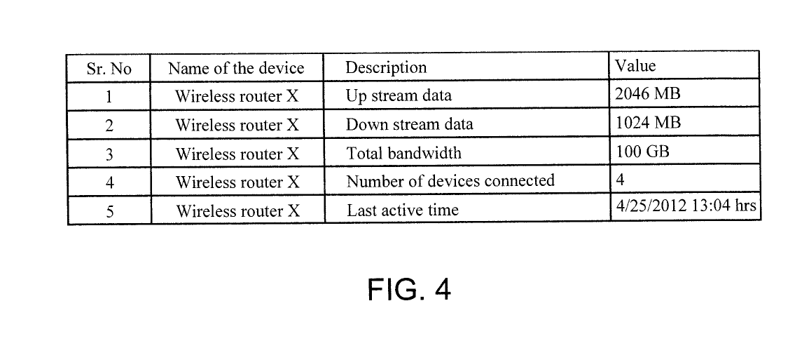

In step 320, the mobile computing device 14 obtains one or more snapshots of the obtained network diagnostic information from step 315. By way of example only, one process for the mobile computing device 14 to obtain snapshot through the network management interface of the network elements 12 provided by respective vendors, although other manners of obtaining one or more snapshots from a designated server could be used. In another example, the mobile computing device 14 periodically obtains one or more snapshots from the designated server containing the network diagnostic information of the non-functioning network elements 12. As illustrated in FIG. 4, the one or more snapshots includes network diagnostic information such as upstream data, downstream data, total bandwidth of the particular non-functional one or more network element, although the one or more snapshot can include any additional network related information.

In step 325, the mobile computing device 14 optionally captures one or more images on the non-functional one or more network elements 12. By way of example only, the mobile computing device 14 may obtain identification information from the non-functional one or more network elements 12, use that information to determine based on stored data what image(s) of the identified non-functional one or more network elements 12 may be helpful for diagnostic purposes, and then display a request for the desired image(s) on the mobile computing device 14 so a user can capture them. The mobile computing device 14 captures the image(s) of the non-functional one or more network elements one or more different sides and angles, although the one or more images can be taken from other orientations to capture other information. The captured one or more images assist in understanding the actual physical arrangement and/or setup of the non-functional one or more network elements 12 to help identify a potential cause of the non-functional one or more network elements.

In step 330, the mobile computing device 14 provides obtained one or more snapshots from step 320 and the captured one or more images from step 325 to the management server 16. By way of example only, the management server 16 uses the one or more snapshots and the captured image to identify the problem associated with the non-functional one or more network elements 12 and perform one or more actions to repair the non-functional one or more network element 12. The one or more actions can be correcting the non-functional one or more network element 12 remotely or deciding to send a technician to correct the non-functional one or more network element 12, although other types of actions can be performed to repair the non-functional one or more network elements 12. Additionally, the mobile computing device 14 can assist the network manager sever 16 in performing one or more actions by receiving one or more instructions from the management server 16 and transferring the received instructions to the non-functional one or more network element 12.

Accordingly, as illustrated above this technology provides more effective methods, non-transitory computer readable medium and devices for managing network elements within a network environment. Additionally, this technology enables access a network even if the network is isolated or if there are issues with an access layer of the network.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for managing network elements within a network environment comprising:
interacting by a mobile computing device with one or more network elements to determine one or more non-functional ones of the network elements;
obtaining by the mobile computing device network diagnostic information from the determined one or more non-functional ones of the network elements;
generating by the mobile computing device one or more snapshots of the determined one or more non-functional ones of the network elements based on the obtained network diagnostic information; and
providing by the mobile computing device the generated one or more snapshots of the determined one or more non-functional ones of the network elements to a management server.

2. The method as set forth in claim 1 wherein the interacting further comprises:
interacting by the mobile computing device with the one or more network elements using one or more real time communication protocols.

3. The method as set forth in claim 1 wherein the obtaining further comprises:
obtaining by the mobile computing device the network diagnostic information by executing one or more network diagnostic tests on the determined one or more non-functional ones of the network elements.

4. The method as set forth in claim 1 further comprising:
capturing by the mobile computing device an image of the determined one or more non-functional ones of the network elements.

5. The method as set forth in claim 4 further comprising:
providing by the mobile computing device the captured image of the determined one or more non-functional ones of the network elements to the management server.

6. A non-transitory computer readable medium having stored thereon instructions for managing network elements within a network environment comprising machine executable code which when executed by at least one processor, causes the processor to perform steps comprising:
interacting with one or more network elements to determine one or more non-functional ones of the network elements;
obtaining a network diagnostic information from the determined one or more non-functional ones of the network elements;
generating one or more snapshots of the determined one or more non-functional ones of the network elements based on the obtained network diagnostic information; and
providing the generated one or more snapshots of the determined one or more non-functional ones of the network elements to a management server.

7. The medium as set forth in claim 6 wherein the interacting further comprises:
interacting with the one or more network elements using one or more real time communication protocols.

8. The medium as set forth in claim 6 wherein the obtaining further comprises:
obtaining the network diagnostic information by executing one or more network diagnostic tests on the determined one or more non-functional ones of the network elements.

9. The medium as set forth in claim 6 further comprising:
capturing an image of the determined one or more non-functional ones of the network elements.

10. The medium as set forth in claim 9 further comprising:
providing the captured image of the determined one or more non-functional ones of the network elements to the management server.

11. A mobile computing device comprising:
one or more processors;
a memory, wherein the memory coupled to the one or more processors which are configured to execute programmed instructions stored in the memory comprising:
interacting with one or more network elements to one or more non-functional ones of the network elements;
obtaining a network diagnostic information from the determined non-functional one or more network elements;
generating one or more snapshots of the determined one or more non-functional ones of the network elements based on the obtained network diagnostic information; and
providing the generated one or more snapshots of the determined one or more non-functional ones of the network elements to a management server.

12. The device as set forth in claim 11 wherein the one or more processors is further configured to execute programmed instructions stored in the memory wherein the interacting further comprises interacting with the one or more network elements using one or more real time communication protocols.

13. The device as set forth in claim 11 wherein the one or more processors is further configured to execute programmed instructions stored in the memory wherein the obtaining further comprises obtaining the network diagnostic information by executing one or more network diagnostic tests on the determined one or more non-functional ones of the network elements.

14. The device as set forth in claim 11 wherein the one or more processors is further configured to execute programmed instructions stored in the memory further comprising capturing an image of the determined one or more non-functional ones of the network elements.

15. The device as set forth in claim 14 wherein the one or more processors is further configured to execute programmed instructions stored in the memory further comprising:
providing the captured image of the determined one or more non-functional ones of the network elements to the management server.
